(19) United States
(12) Patent Application Publication
(10) Pub. No.: US 2004/0013498 A1
(43) Pub. Date: Jan. 22, 2004

(54) Apparatus and methods for semiconductor wafer processing equipment

(76) Inventors: Alan J. Soucy, Georgetown, MA (US); James S. Castantini, Newburyport, MA (US); Kevin Hoyt, Sandown, NH (US)

Correspondence Address: TESTA, HURWITZ & THIBEAULT, LLP, HIGH STREET TOWER, 125 HIGH STREET, BOSTON, MA, 02110, US

(21) Appl. No.: 09/897,820

(22) Filed: Jun. 29, 2001

Related U.S. Application Data
(60) Provisional application No. 60/215,584, filed on Jun. 30, 2000.
(60) Provisional application No. 60/242,127, filed on Oct. 20, 2000.

(51) Int. Cl. B65G 49/07

(52) U.S. Cl. 414/217

(57) ABSTRACT

The invention relates generally to equipment for semiconductor wafer processing, for example, mechanisms and apparatus for handling pods or containers for housing silicon wafers or substrates. The pod may be a front-opening unified pod or similar article and may house a carrier or cassette for holding the wafers or substrates. Additionally, the invention relates generally to an automated system for transporting a plurality of wafers in the pod for processing, loading the pod on the receiving station, sealing the pod against an interface, opening the door of the pod, and shuttling the wafers into and out of a connected clean environment processing station, such as an ion implantation machine, using a robotic device.

### CROSS-REFERENCE TO RELATED APPLICATIONS

This application incorporates by reference, and claims priority to, and the benefit of, U.S. Provisional Patent Application Serial Nos. 60/215,584, filed on Jun. 30, 2000, and 60/242,127, filed on Oct. 20, 2000.

### TECHNICAL FIELD

The invention relates generally to equipment for semiconductor wafer processing, for example, mechanisms and apparatus for handling pods or containers for housing silicon wafers or substrates. In particular, the invention relates to pod door openers and related equipment used to remove and store the sealed pod door during wafer processing.

### BACKGROUND INFORMATION

The manufacture of integrated circuits (I.C.'s) begins with blank, unpatterned semiconductor wafers. These wafers undergo a number of sometimes critical process steps before being formed into the final I.C. form. A substandard wafer can affect the number of usable I.C.'s on a wafer, commonly referred to as yield. It is, therefore, desirable to have a machine for testing wafers to ensure the wafers meet a customer's standards and to maximize wafer yield.

The testing of wafers is often accomplished by an automated process, in which robots continuously handle and test the wafers. Robotic testing and handling tends to be more efficient than manual testing and handling of wafers, since robots can be much faster, more precise, and less contaminating than human operators when handling wafers. In wafer handling processes, wafers are typically transported using carriers such as wafer cassettes or wafer pods. Pods differ from cassettes in that the pods typically are sealed to prevent contamination of the wafers enclosed therein.

Previously, wafers having a diameter of 200 mm or 8 inches were commonly used in the semiconductor industry for the manufacture of I.C.'s. More recently, 300 mm or 12-inch diameter wafers have been introduced to allow a greater number of integrated circuits to be produced from one wafer, thus lowering the cost of producing the I.C.'s. New equipment and procedures have been developed to handle and process these new, larger wafers. For example, new larger, standard wafer pods, commonly referred to as Front Opening Unified Pods (FOUPs), have been developed. These sealed pods provide a contamination-free storage and transport environment for the wafers. To unload the wafers, the pod is positioned so that the wafers are oriented horizontally, the front door of the pod is opened to a contamination-free environment inside the testing equipment, and a robot end-effector is used to remove a wafer for processing or testing. Other versions of pods are used for smaller sized wafers; for example, Standard Mechanical Interface (SMIF) pods are typically used for 5-inch, 6-inch, and 8-inch wafers.

This application incorporates by reference in their entirety the disclosures of the following U.S. Pat. Nos.: 6,071,059 Loading and Unloading Station for Semiconductor Processing Installations; 6,053,688 Method and Apparatus for Loading and Unloading Wafers from a Wafer Carrier; and 5,772,386 Loading and Unloading Station for Semiconductor Processing Installations.

### SUMMARY OF THE INVENTION

The current state of the art consists of complex pod door openers that require a large spatial working volume. The invention described herein is electromechanically novel, compact, highly reliable, and requires a minimal spatial volume to perform the same functionality as current state of the art systems. For example, the pod door opener is used for removing and storing the pod door during wafer processing, permitting loading and unloading of the 300 mm wafers relative to the pod. The pod requires the use of an apparatus to dock (or undock) the pod, unlatch (or latch) the sealed door, and to hold the pod securely during processing of the wafers. Further, the pod door opener provides a standard interface for mounting the pod to the wafer processing equipment. Semiconductor Equipment and Materials International (SEMI) standards control the mechanical interface requirements to maintain interchangeability and compatibility between pod manufacturers and processing equipment suppliers.

Various embodiments of the invention are depicted in the configuration, layout, and design of the equipment and systems described and illustrated in the accompanying figures. The invention provides an efficient, unique, compact, highly reliable pod door opener (PDO). A PDO, in accordance with the invention, is less complicated and more reliable than conventional PDOs, operating within a significantly smaller total work volume by axially retracting and lowering the pod door, instead of pivoting the pod door about a transverse axis and then lowering the door.

This fully automated system receives conventional semiconductor wafer sealed pods containing up to thirteen or twenty-five wafers, the pod doors incorporating two 90 degree door latches. A robot or other transport device deposits the pod onto a seating plate of the receiving station, which interfaces with a clean room of a semiconductor wafer processing tool, typically under positive pressure to prevent the ingress of contaminants. A locking mechanism locks the pod to the receiving station and pneumatic cylinders or other actuators may be employed to move the pod in a transverse direction to seal the pod against the interface plate and unlock and retract the pod door. A mechanical lead screw and ball nut or other transmission mechanism may be employed to lower the door to provide access for a robotic wafer handler to remove the wafers for processing and thereafter replace the wafers in the pod. The invention can be retrofitted and used in current, conventional semiconductor wafer processing systems providing enhanced reliability and smaller total operating volume.

In one embodiment, the pod is presented to an interface plate of the apparatus, often referred to as a FIMS (front opening interface mechanical standard) plate by those skilled in the art. The pod is seated on a three pin kinematic mount and locked into place using a centrally disposed pneumatically driven rotary latch once one “presence” and three “in-place” sensors indicate the pod is properly located. The pod is translated and sealed against the processing equipment interface plate using a compact pneumatic cylinder, which is maintained under pressure until the pod is to be retracted. Suction cups with integral locating pins interface positively with the pod door. Once sealed, the pod door is unlatched using a flat pack single pneumatic cylinder to drive a dual output, double acting scotch yoke. A pneumatic cylinder, riding on linear carriage ways, then retracts the door horizontally. A vertically disposed electrical optic sensor confirms that the wafers have not extended beyond the plane of the door and then the door is lowered along the vertical or Z axis, driven by an electric DC servo motor, belt, and centrally disposed lead screw. Advantageously, the electrical and pneumatic control systems may be mounted on the pod side of the interface, to facilitate troubleshooting and repair, as required.

In one aspect, the invention relates to a pod door opener including a door opening mechanism, a bulkhead having a seal plane and defining an aperture through which the door of a pod passes when removed by the door opening mechanism, and a work volume for the door opening mechanism. The work volume has a height, width, and depth, and the depth does not exceed about 80 mm from the seal plane. In various embodiments, the width does not exceed about 400 mm, generally horizontally centered on the seal plane, and the height does not exceed about 439 mm, generally vertically centered on the seal plane. In further embodiments, the pod door opener is configured to mount to a semiconductor wafer processing tool that permits a work volume for the door opening mechanism to have a depth of up to about 100 mm and/or a width of up to about 414 mm. Also, the bulkhead can be of a monocoque type construction.

The door opening mechanism moves the pod door in a horizontal direction and a vertical direction and may include a door retraction device. The door retraction device includes a bidirectional propulsion device, such as an electromechanical system, an hydraulic system, a pneumatic system, or combinations thereof. The door opening mechanism may also include a vertical positioning system. The vertical positioning system can include a lead screw, a conformal rolling nut, and a motor. The vertical positioning system could also be a guided telescopic lift device, a linear electric motor, a cam driven system, an hydraulic actuator, a pneumatic actuator, a cable drive system, a magnetically coupled device, or combinations thereof.

In still other embodiments, the pod door opener can include optionally a pinch avoidance system, a door key latch mechanism for grasping the pod door, and apparatus for sensing the presence and/or placement of the pod. The pinch avoidance system detects an obstruction and can include a frame coupled to the bulkhead and at least one switch disposed between the frame and the bulkhead. The door key latch mechanism includes a door interface plate coupled to the pod door opener, at least one door key latch coupled to the interface plate, a bi-directional propulsion device coupled to the interface plate, and a yoke coupled between the door key latch and the bi-directional propulsion device. The yoke translates a linear motion from the bidirectional propulsion device to a rotary motion on the door key latch. The bi-directional propulsion device can be an electromechanical system, an hydraulic system, a pneumatic system, or combinations thereof. The apparatus for sensing placement and position of the pod can include, for example, at least one flag and at least one sensing devices, such as be a proximity switch, a limit switch, an optical sensor, or similar device.

In another aspect, the invention relates to a kinematic tool interface system for use with a pod door opener. The kinematic tool interface system includes a lower interface, at least one kinematic pin, and a seismic anchoring device. The lower interface includes a kinematic shelf and at least one support bracket. The kinematic shelf and support bracket can be coupled rigidly to a wafer processing tool. The kinematic pin is disposed on the kinematic shelf and is independently adjustable with a range sufficient to accommodate pitch, roll, and yaw adjustments to the pod door opener. The seismic anchoring device is disposed through an underside of the kinematic shelf. In one embodiment, the kinematic tool interface system includes at least one upper interface for securing the pod door opener to the wafer-processing tool.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings in which:

FIGS. 1A-1C are isometric views of a prior art pod door opener;

FIG. 1D is a side view of the prior art pod door opener of FIGS. 1A-1C;

FIGS. 2A-2B are schematic top and side views of one embodiment of a pod door opener in accordance with the invention;

FIG. 2C is a schematic view of a seal plane of the embodiment of the pod door opener shown in FIGS. 2A-2B;

FIG. 3 is an isometric view of the pod side of another embodiment of a pod door opener in accordance with the invention;

FIG. 4 is an isometric view of the equipment side of the pod door opener of FIG. 3;

FIGS. 5A-5D are isometric views of a pod latching and drive system in accordance with the invention;

FIGS. 6A-6B are isometric views of a pod door chucking and retraction system in accordance with the invention;

FIG. 6C is a cross-sectional view of one door key latch of FIG. 6A taken along line 6C-6C;

FIG. 7 is an isometric view of a vertical positioning system in accordance with the invention;

FIG. 8A is schematic view of an operator pinch avoidance system in accordance with the invention;

FIG. 8B is a cross-sectional view of the operator pinch avoidance system of FIG. 8A taken along line 8B-8B;

FIGS. 9A-9B are isometric views of one embodiment of a kinematic tool interface system in accordance with the invention;

FIG. 9C is a cross-sectional view of an upper interface of the kinematic tool interface system of FIGS. 9A-9B taken along line 9C-9C;

FIG. 9D is an enlarged schematic view of the upper interface of the kinematic tool interface system of FIGS. 9A-9C; and

FIGS. 10A-10H are wiring diagrams for various components of a pod door opener in accordance with the invention.

### DESCRIPTION

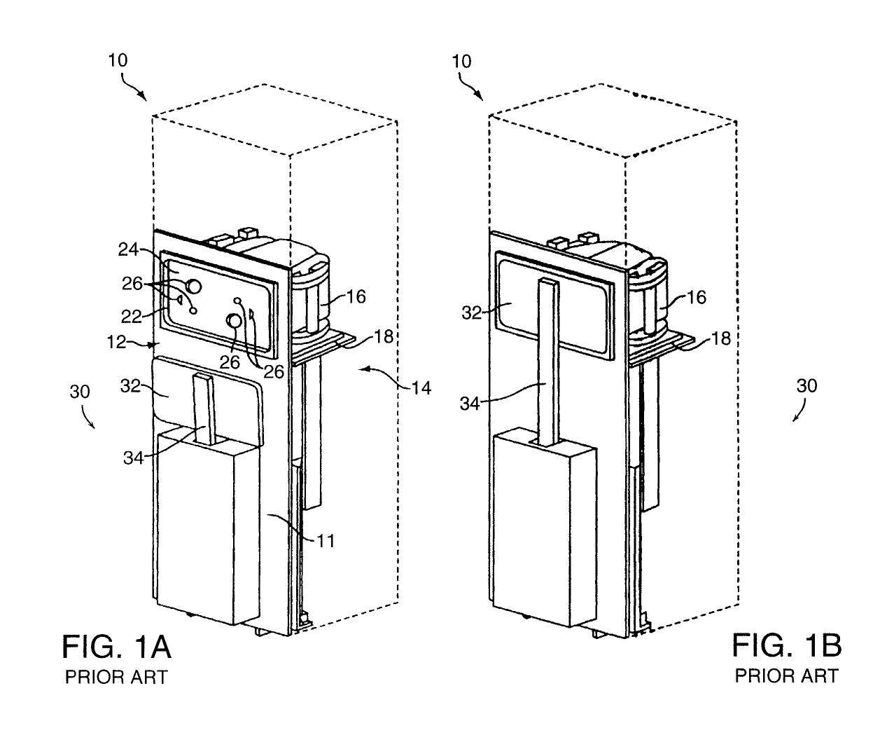

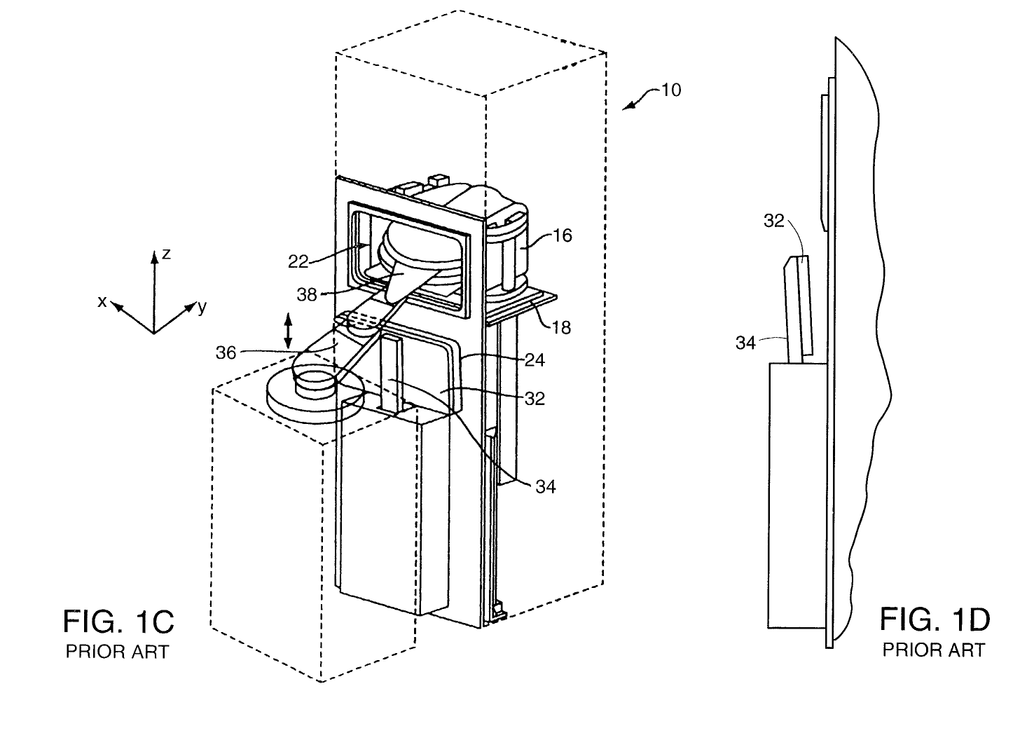

One tool for use with contamination-free handling of wafers is a load port, also referred to herein as a pod door opener (PDO). The load port allows a wafer carrier or pod to dock to a wafer processing tool while providing a continuous, clean environment for wafers as they are unloaded from the pod by an end-effector mechanism. One typical example of a prior art load port is illustrated in FIGS. 1A-1C. In FIG. 1A, load port mechanism 10 includes a panel 11 having an equipment side 12 and a pod side 14. On the pod side 14 of panel 11, a pod 16 is positioned on an unloading station 18 and includes one or more wafers. In some embodiments of load port mechanisms, additional pods can be loaded in the mechanism 10 and can each be moved into the unloading position once the wafers of pod 16 have been unloaded, processed, and tested.

On the equipment side 12 of panel 11, the load port mechanism 10 includes an opening 22 in panel 11, which has approximately the same dimensions as a front door 24 of the pod 16. The front door 24 is aligned with the opening 22, whereby contamination is prevented from entering the clean environment on the equipment side 12 by exerting positive air pressure inside the clean environment. Pod front door 24 includes several fastening mechanisms 26, such as registration pins, door key latches, vacuum fasteners, and optionally, purge ports for the introduction/withdrawal of gases from the pod 16.

The load port mechanism 10 also includes a door removing mechanism 30, which includes a plate 32 and a support rod 34. The plate 32 and rod 34 are shown in a lowered position in FIG. 1A. FIG. 1B illustrates the load port mechanism 10 of FIG. 1A with the door removing mechanism 30 moved into position to remove the front door 24 of the pod 16. Plate 32 has been raised by support rod 34 by motors or other mechanisms to the level of door 24 and opening 22. The plate 32 and rod 34 are then moved toward the opening 22 and plate 32 is inserted into the opening to engage the door 24. Plate 32 includes components that mate with the fastening mechanisms 26 on the front door. For example, plate 32 can include apertures into which pins on door 24 fit, door key latches to unlock a latch securing the door, etc. In some embodiments, vacuum pressure can be used to assist the plate 32 in mating with door 24.

FIG. 1C illustrates the prior art load port mechanism 10 after the door removing mechanism 30 has removed the front door 24 from the pod 16. The plate 32 and rod 34 are tilted back angularly from the inserted position of FIG. 1B, where the door 24 is attached to plate 32 requiring a very large work volume. See FIG. 1D. The plate 32 and door 24 are then lowered to the position shown in FIG. 1C. Since the wafers in pod 16 are now accessible through opening 22, a robot having z-axis movement such as handler arm 36 and end-effector 38 can be used to remove one or more wafers, one at a time, and transport the wafers to another testing or processing station inside the clean environment. The pod 16 remains stationary as the robot is moved to different elevations to take out the wafers. The robot loads the wafers into the pod in the same way that the wafers are unloaded after the wafers have been tested or processed.

For purposes of semiconductor wafer processing with a pod, it is important to have a system that can remove and replace automatically the sealed door of the pod. In the prior art systems, the physical size and complexity of the pod door opener are cumbersome to the end user and prone to malfunction and failure. Additionally, installation and alignment of prior art systems to wafer processing equipment are difficult. The present PDO has been developed to minimize weight and spatial volume requirements. It is also simpler to install and align to semiconductor manufacturing equipment. All major subsystems have been developed in a modular fashion, which reduces the overall complexity of the semiconductor wafer processing equipment.

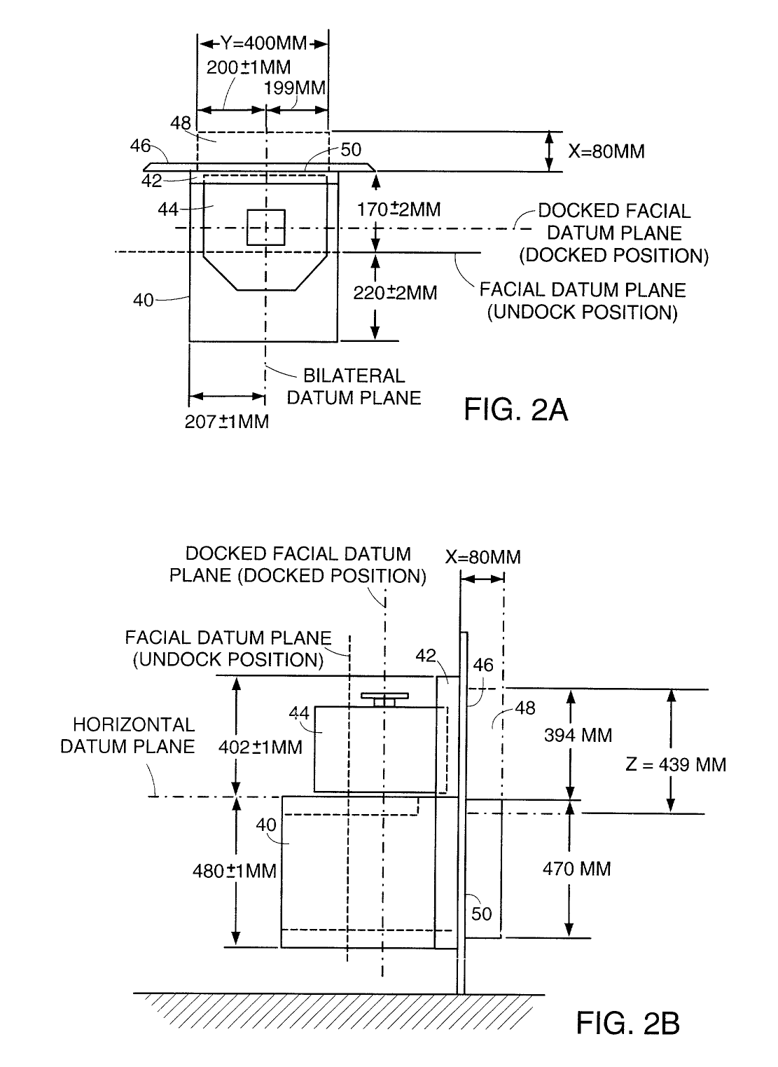

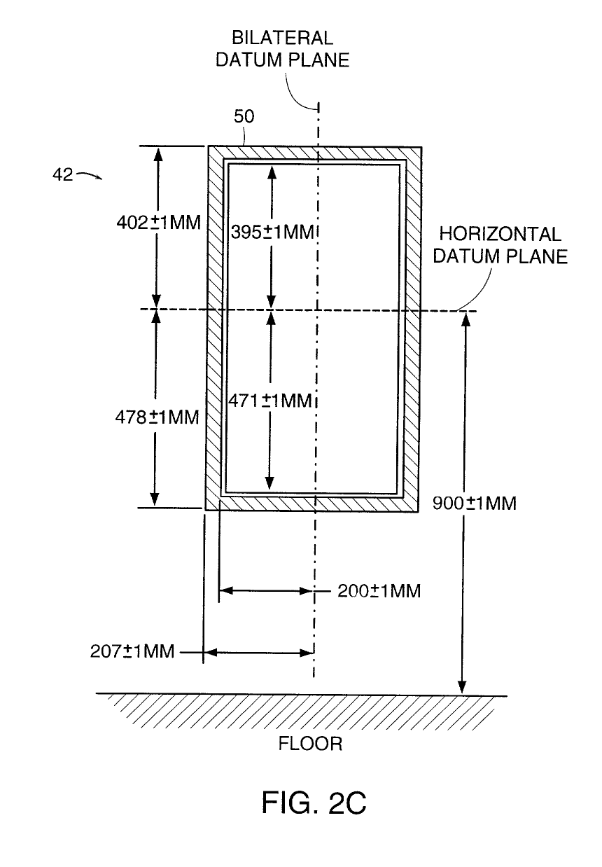

FIGS. 2A-2B depict top and side views, respectively, of a PDO 40 in accordance with the invention. In the figures, the PDO 40 is attached to a wafer processing tool 46 by a bulkhead 42. A pod 44 is shown installed on the PDO 40. The PDO 40 includes a variety of equipment and subsystems that operate to open and remove a door from the pod 44. In part due to the modular design, the aforementioned equipment and subsystems operate within a reduced work volume 48, as compared to prior art systems. The work volume 48 has a depth (X), a width (Y), and a height (Z). The work volume is measured from a seal plane 50, which is the side of the bulkhead 42 that interfaces with the wafer processing tool 46. The seal plane 50 is illustrated in FIG. 2C.

In the embodiment illustrated in FIGS. 2A-2C, the maximum work volume 48 dimensions are as follows: X=80 mm, Y=400 mm, and Z=439 mm. The additional dimensions shown are approximate and are for illustrative purposes only. Apparatus dimension greater than or less than these dimensions are considered to be within the scope of the invention. Additionally, several of the dimensions are given relative to a horizontal datum plane, a facial datum plane, a docked facial datum plane, and/or a bilateral datum plane. Generally, the horizontal datum plane is a horizontal plane that projects from the kinematic coupling pins on which the pod sits, the facial datum plane is a vertical plane that bisects the wafers and is parallel to the front side of the pod, the docked facial datum plane is the same as the facial datum plane, but with the pod in the docked position, and the bilateral datum plane is a vertical plane that bisects the wafers and is perpendicular to both the facial and horizontal datum planes. These datum planes are further described in SEMI standards nos. SEMI E92-0200E Provisional Specification for 300 mm Light Weight and Compact Box Opener/Loader to Tool-Interoperability Standard (Bolts/Light), SEMI E15-0698 Specification for Tool Load Port, SEMI E15.1-0600 Provisional Specification for 300 mm Tool Load Port, and SEMI E57-0600 Provisional Mechanical Specification for Boxes and Pods Used to Transport and Store 300 mm Wafers, the entireties of which are hereby incorporated herein by reference.

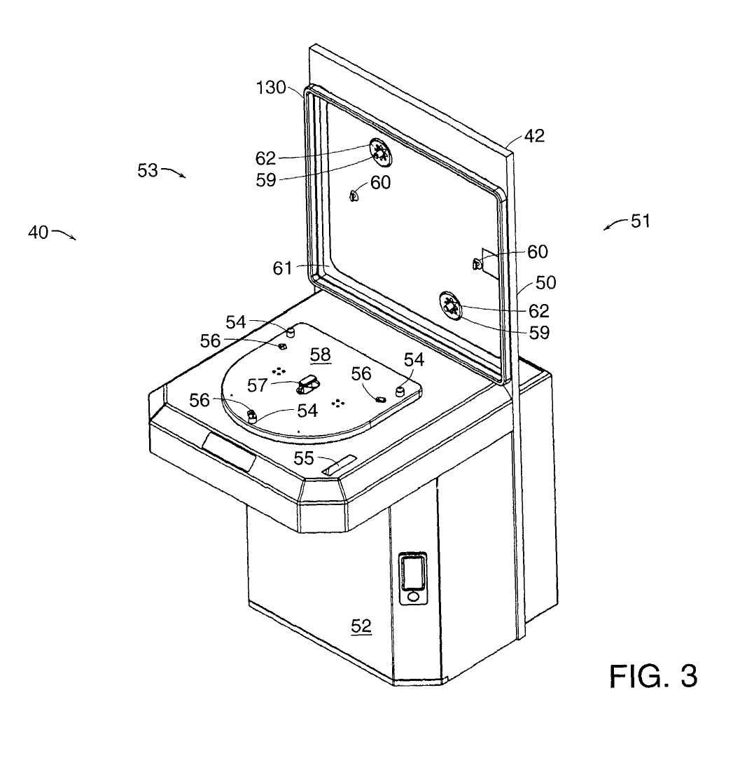

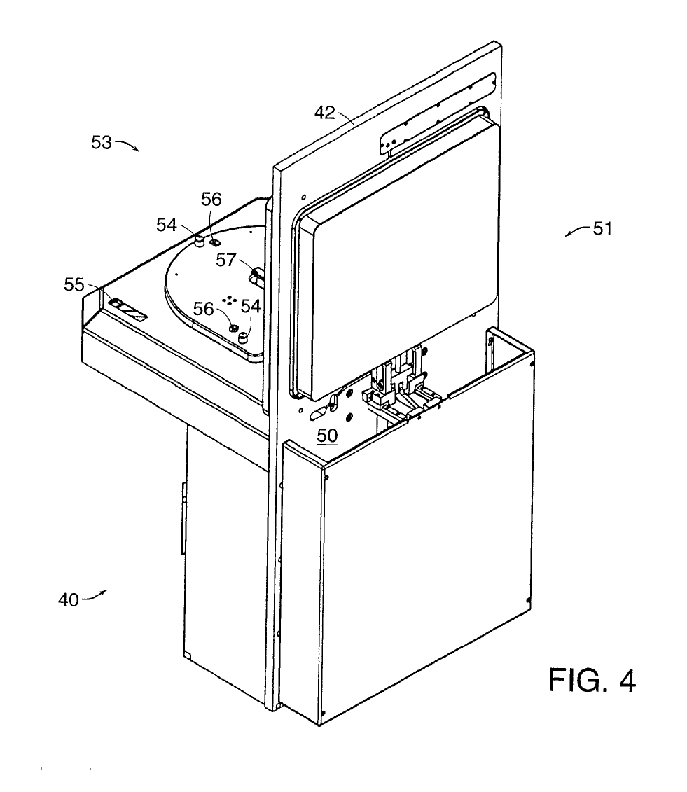

A system overview describing the operation of various aspects of the invention will be described next with respect to FIGS. 3 and 4. FIG. 3 illustrates the system components as viewed from the operator or pod side 53. This is the side from which the pod 44 is loaded and unloaded. The bulkhead 42 acts as the primary structural member for the entire system and is durable and lightweight. The bulkhead 42 may be of a monocoque construction, such that the outer skin absorbs substantially all of the stresses to which the body is subjected. This typically entails the use of an outer structural frame with lightweight structural filler materials enclosed within a thin membrane. In one embodiment, the bulkhead 42 is a thin singular plate to which all subsystems and components are attached. The bulkhead 42 also provides a precise interface surface to the wafer processing tool 46. This interface surface, or seal plane 50, is best seen in FIG. 4 and prevents the migration of airborne contaminants from the operator or pod side 53 to the equipment side 51.

In normal operation, the pod 44 is placed on the three kinematic pins 54 by an operator or by an automated material handling system. A presence sensor 55 and a series of three placed sensors 56 verify that the pod 44 is both present and correctly placed on the kinematic pins 54. Once verified, further system motion is allowed. First, a pod latch 57 is actuated to hold the pod 44 in place on the kinematic pins 54. The pod latch 57 holds the pod 44 and its contents, the silicon wafers, securely during processing. After latching, the pod 44 is moved to a docked position against the bulkhead 42 by a pod drive 58. The bulkhead 42 has an integral rim feature that provides a sealing surface 61 for the pod enclosure 44. This sealing surface 61 is used to prevent the migration of airborne contaminants from reaching the contents of the pod 44. As the pod 44 docks, door pins 59 and door key latches 60 engage with corresponding features in the removable pod door. The door pins 59 provide positional accuracy and repeatability, which ensures proper chucking of the pod door. The door key latches 60 are rotated and the pod door is ready for removal from the pod 44. Vacuum suction is provided coaxially about the door pins 59 by suction cups 62, which aid in the door chucking process. Once the pod door is properly chucked, the door is retracted from the pod 44 and is lowered into a position that does not interfere with the wafer transfer robotic apparatus. Once the wafer transfer process is complete, the reverse order of events occurs such that the pod 44 is ready for removal from the PDO 40. Further, the compact nature of the invention allows for sufficient internal volume to provide modular control components. An access door 52 provides the required accessibility to all control system components.

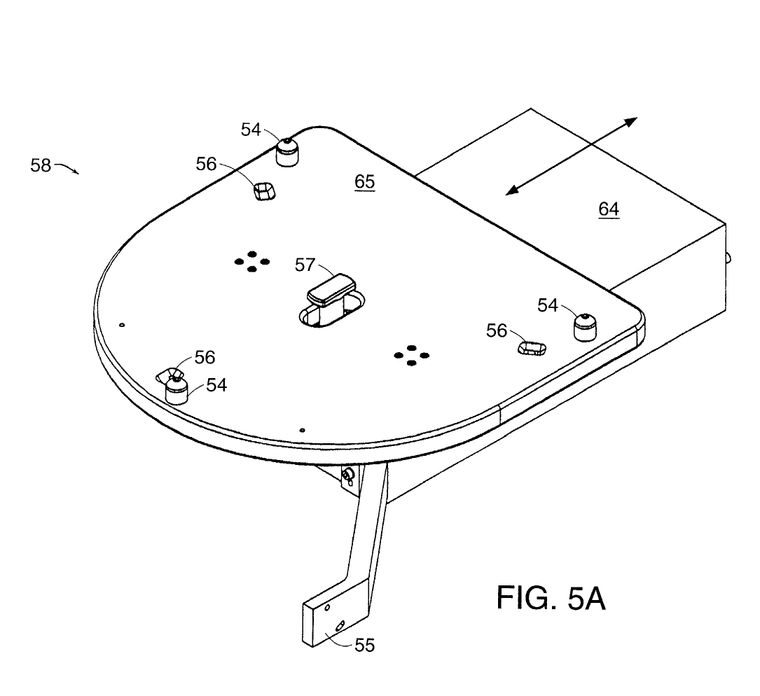

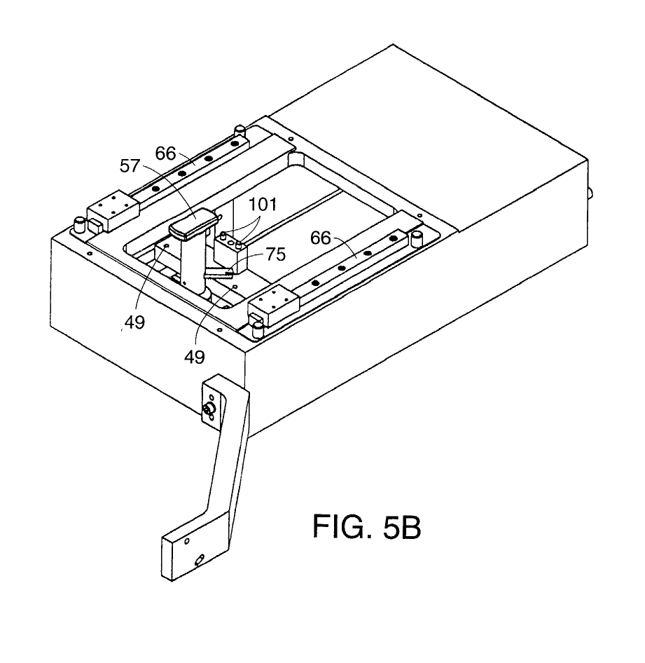

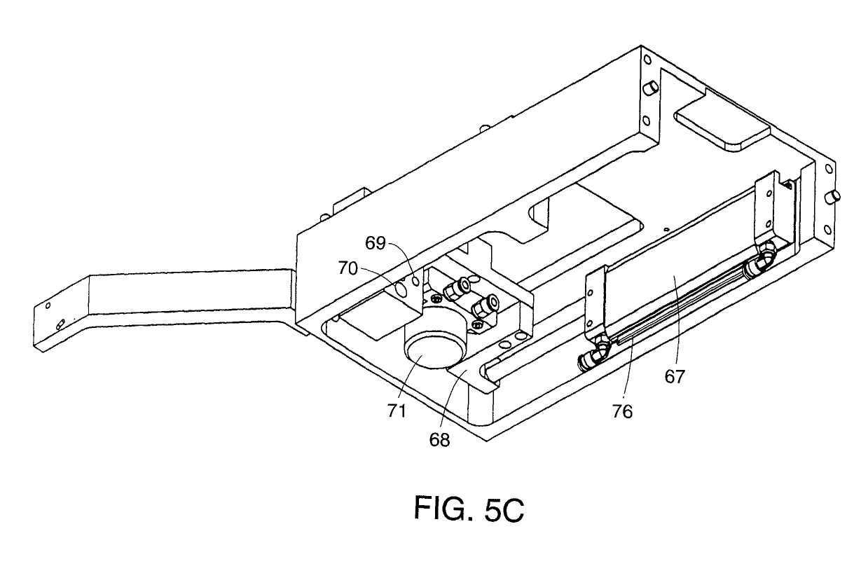

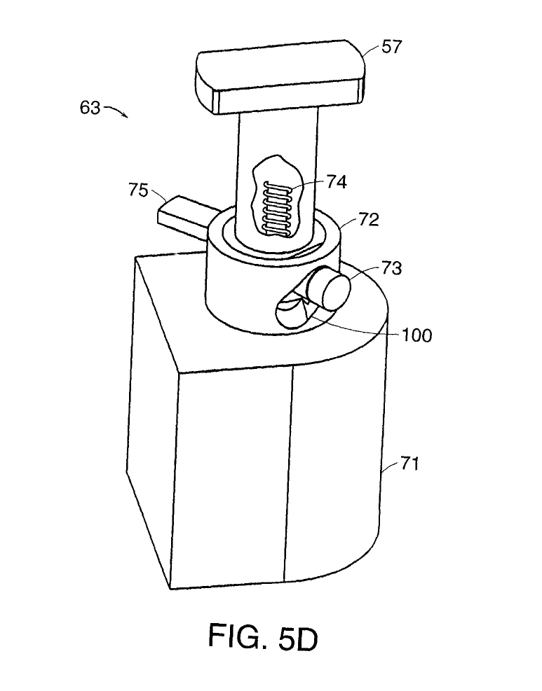

All pod motions as well as the presence and placement functions are managed by a pod drive 58. FIGS. 5A-5D illustrate the pod drive 58 and its components. The pod drive housing 64 provides structural support for the associated drive components and payload, as well as a rigid and precise coupling to the bulkhead 42. The pod 44 is placed on a series of kinematic pins 54. Three kinematic pins 54 are shown; however, the number and position of the kinematic pins 54 may vary to suit a particular application. The kinematic pins 54 are rigidly attached to a support plate 65, which moves in a fore and aft direction to accomplish pod 44 docking and undocking functions. The fore and aft motions are accomplished by a pair of linear bearing devices 66 (FIG. 5B) and a bi-directional propulsion device 67 (FIG. 5C). The bidirectional propulsion device 67 could be of electromechanical, pneumatic, or hydraulic form, for example a pneumatic actuator. A rigid coupling 68 connects the propulsion device 67 and the support plate 65. Fore and aft travel distances are adjusted by stops 69 and energy absorption devices 70 (FIG. 5C). Sensing devices 76 are utilized to provide positional feedback to the control system. Sensing devices 76 can, for example, include proximity or limit switches.

As previously noted, the pod latch 57 holds the pod 44 securely in place on the kinematic pins 54. The pod 44 generally has provisions on the underside for holding, with a feature located at a forward portion thereof, near the removable door. Alternatively, the feature is centrally located. The pod latch 57 is rotated by a bi-directional propulsion device 71 that is rigidly coupled to the support plate 65 and could be of electromechanical, pneumatic, or hydraulic form. Several methods of clamping may be used, such as toggle clamps, spring plates and roller devices, cam driven arms, or a rotary pull down device. In the embodiment illustrated in FIG. 5D, a rotary pull down device 63 is used. The rotary pull down device 63 includes the previously mentioned propulsion device 71, which is coupled to the pod latch 57. A coaxial ring 72 is placed over the lower portion of the pod latch 57 and has a radial and axial groove 100 about its periphery. A following device 73 is attached to the pod latch 57 and is guided within the groove 100. A return spring 74 is used to ensure that the pod latch 57 returns to its initial position. When the pod latch 57 is in its unlatched state, the rotary pull down device 63 positions the pod latch 57 in its uppermost position. During the latch cycle, the rotary pull down device 63 positions the pod latch 57 in its lowermost, or clamped, position. The pod latch 57 also has an integral flag 75 control system which, in conjunction with sensing devices 101, provides positional feedback to the system.

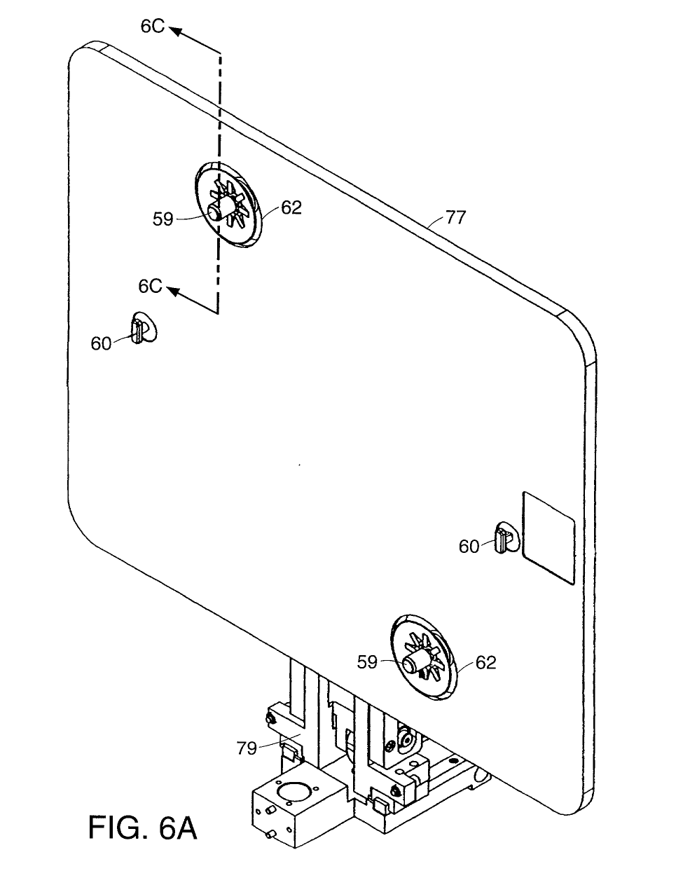

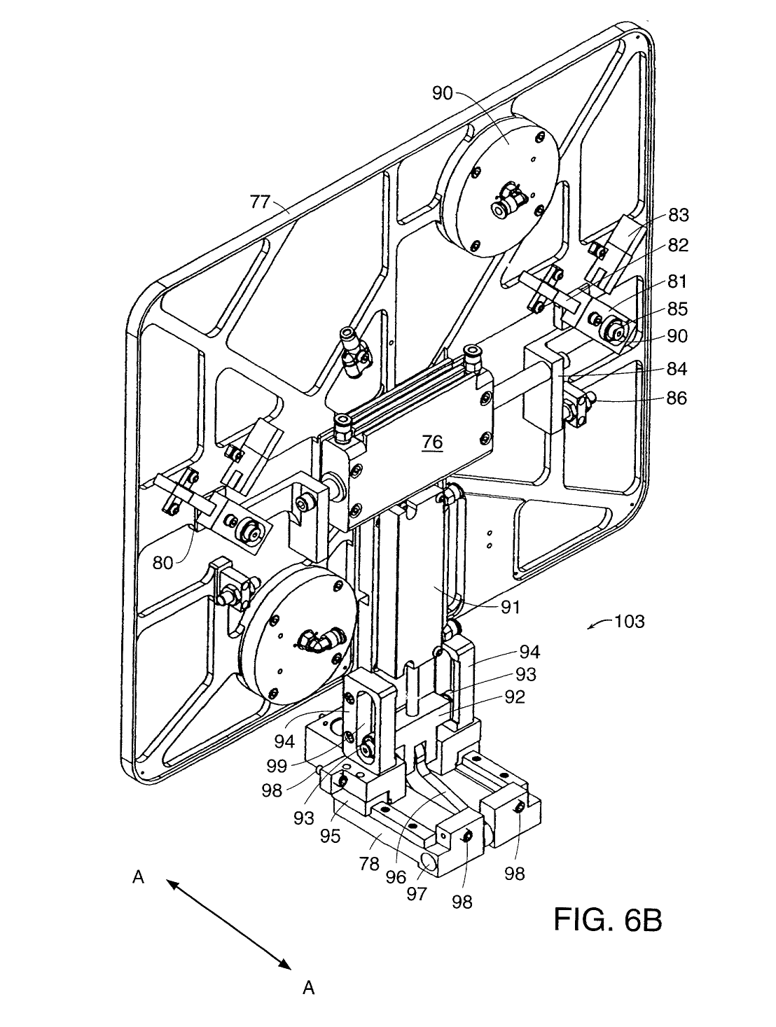

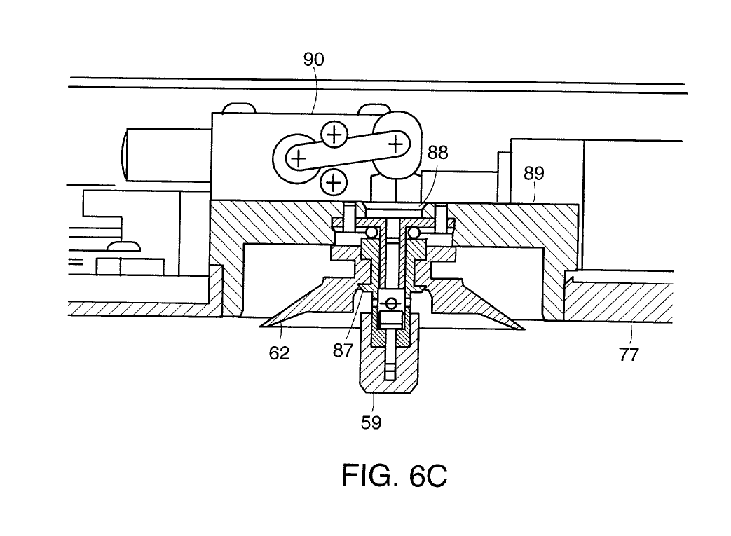

The door chucking and retraction system 103, as illustrated in FIGS. 6A-6C, includes three primary structural members and an assemblage of components to provide the desired motions. The door interface plate 77 is a thin-walled structural element used to support the door latching and vacuum suction components. The support beam 79 is a structurally rigid member used to support the door interface plate 77. The carriage 78 is the third structural member and couples the door chucking and retraction system 103 to a vertical positioning system 104.

As previously mentioned, the door chucking process involves the use of two rotary door key latches 60, which are used to engage or disengage the removable pod door. The door key latches 60 are rotated by a bidirectional propulsion device 76 that is rigidly coupled to the door interface plate 77 and could be of electromechanical, pneumatic, or hydraulic form. A modified scotch yoke translates the linear motion of the propulsion device 76 into the desired rotary latch motion. The door key latch 60 is a precision component that rotates freely in a rigid bearing 80 that is fixed to the door interface plate 77. Attached to the end of the door latch key 60 is a yoke 81, which has an integral flag 82 that, in conjunction with a sensing device 83, provides positional feedback. A lever arm 84 is used to couple the propulsion device 76 to the yoke 81. The lever arm 84 has an attached following device 85 that is disposed in a slot 90 in the yoke 81. An adjustable stop 86 is utilized to limit the phase of rotation of the door key latch 60.

As shown in FIG. 6A, two door alignment pins 59 are utilized. As previously described, the door pins 59 engage with corresponding features in the removable pod door. In one embodiment, the door chucking and retraction system 103 uses two pins 59, one acting as a primary orientation pin and the other as a secondary orientation pin; however, the number and location of the pins 59 may vary, as necessary to mate with the pod 44. As shown in FIG. 6C, the pins 59 are removable and are secured by a coupling 87. The coupling 87 is hollow in nature and provides an unimpeded path for vacuum to reach the suction cup 62. Vacuum leakage is prevented by a seal 88 between the coupling 87 and a support 89, which is precisely oriented in door interface plate 77. Vacuum may be supplied in a number of ways, for example by using a compact venturi device 90, which is located proximate the suction cup 62. Alternatively, vacuum may be supplied by a pumping device.

Door retraction is accomplished by a bi-directional propulsion device 91 that is rigidly coupled to the support beam 79 and could be of electromechanical, pneumatic, or hydraulic form. A yoke 92 is rigidly attached to the end of the propulsion device 91 and has attached following devices 93 that are guided by slots 99 in side supports 94. The support beam 79 is allowed to translate in a horizontal plane (arrows A-A) by a pair of linear bearings 95 that are attached to the carriage 78. A link 96 connects the yoke 92 to the carriage 78 by bearings 97, thereby enabling motion to occur only in the horizontal plane. Fore and aft travel distances are limited by stops 98. This system effectively converts a vertical translation into a horizontal translation, without the need for complex gearing or other apparatus.

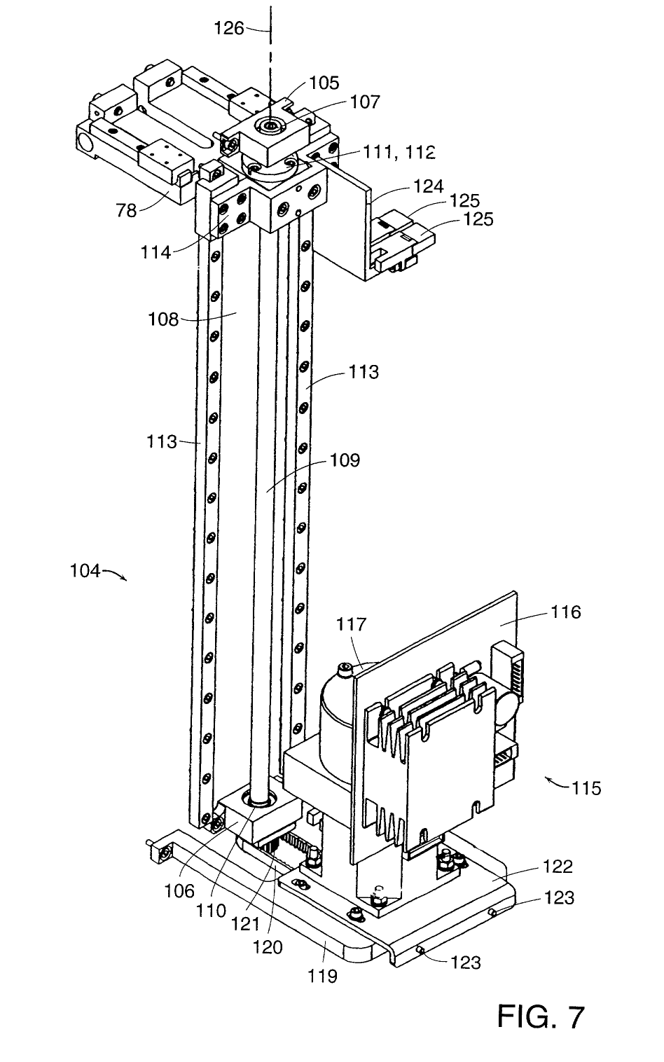

Once retracted, the door 77 can be lowered to a stored position so that the door 77 does not interfere with a robotic wafer transfer apparatus. One embodiment of a vertical positioning system 104 is illustrated in FIG. 7 and is used to raise and lower the door chucking and retraction system 103 along a vertical axis 126. The system 104 is rigidly attached to the bulkhead 42 by an upper bearing housing 105 and a lower bearing housing 106. The upper bearing housing 105 holds a supporting bearing 107 for the upper end 108 of a leadscrew device 109. The lower bearing housing 106 holds a pair of precision bearings 110, which provide rigidity in both the axial and radial directions.

The door chucking and retraction system 103 is coupled to the vertical positioning system 104 by a rolling nut 111. The rolling nut 111 is of a particular design, such that system misalignment is compensated for by a plurality of elastomeric bushings 112. The elastomeric bushings 112 also contribute to smooth motion. A pair of linear bearings 113 are attached to the bulkhead 42 to provide a smooth, guided motion. The carriage 78 is coupled to the linear bearings 113 by a clamp plate 114. The vertical positioning system 104 is driven by a bidirectional rotary propulsion device 115, which could be of electromechanical, pneumatic, or hydraulic form.

In one embodiment, the device 115 is a precision electric motor with an in-situ control 116. A holder 117, such as an electromechanical brake, is attached to the motor shaft to prevent any undesired motion from occurring. The motor 115 is supported by a plate 119, which is rigidly attached to the bulkhead 42. Motor torque is transmitted to the leadscrew 109 by a toothed drive belt 120 and pulley system 121. Proper belt tension is accomplished by adjustment of a sliding plate 122 and guided springs 123. Position verification is accomplished by use of a flag 124, which is rigidly attached to the clamp plate 114. Sensors 125 are used to determine the presence of the flag 124.

Several alternative techniques are possible to perform the desired functions of the vertical positioning system. Among these are a guided telescoping lift device, other linear propulsion devices, such as linear electric motors, magnetically coupled devices, cables or straps guided by pulleys and controlled with counterweights, cam driven systems, and hydraulic or pneumatic actuators.

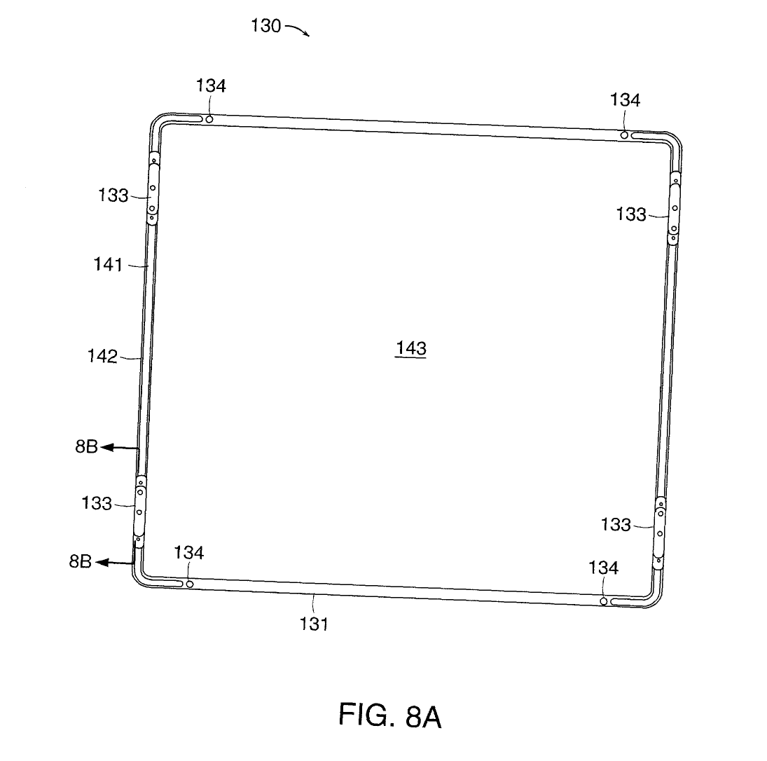

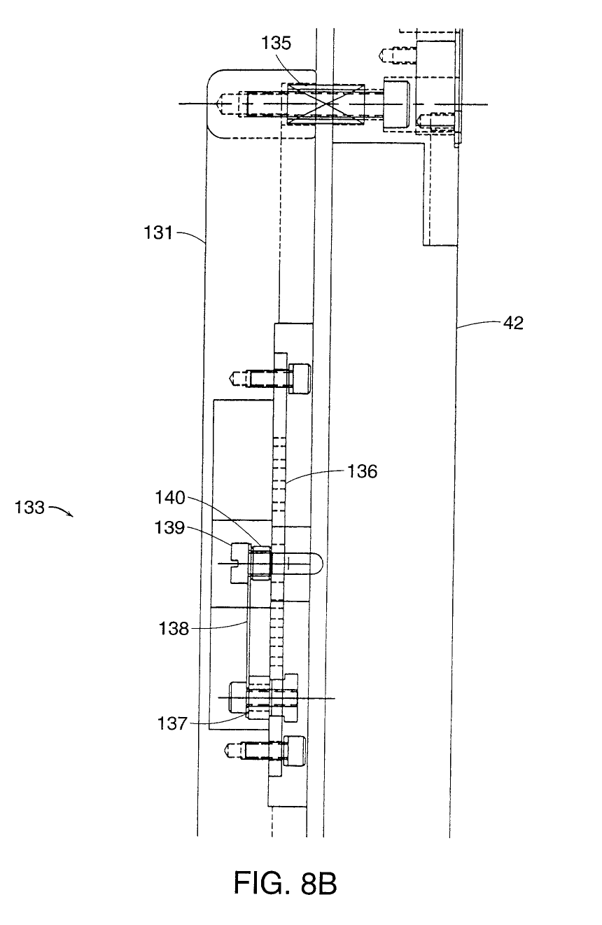

In order to prevent an operator from becoming pinched by the pod docking motion, a pinch avoidance system 130 is provided. FIG. 3 illustrates the orientation of the pinch avoidance system 130 as implemented on the PDO 40. FIG. 8A illustrates one embodiment of the pinch avoidance system 130. The system 130 includes a lightweight frame 131 that circumscribes the pod docking opening 143 within the bulkhead 42. If an object should become trapped between the pod 44 and the frame 131 when the pod 44 is being advanced, the frame 131 is pushed toward the bulkhead 42 and a series switch circuit 132 opens. In one embodiment, there are four switches 133 located about the frame 131, such that a force applied at any point along the frame 131 will open the switch circuit 132. The quantity and location of the switches 133 can be varied to suit a particular application. The pod docking motion is reversed immediately upon the switch circuit 132 changing to an open state.

The pinch avoidance system 130 includes a number of components. The frame 131 is attached to the bulkhead 42 by a plurality of screws 134, which provide rigid coupling to the bulkhead 42 as well as guidance for return springs 135. As best seen in FIG. 8B, the switches 133 include a mounting plate 136 rigidly attached to the frame 131, a spacer 137, a spring plate 138, and a bumper 139 which, when depressed, lifts the contact ring 140 off of the mounting plate 136, thereby opening the circuit 132. To facilitate manufacturability and maintain a low physical profile, switch pockets 141 and wiring channels 142 may be formed in the frame 131.

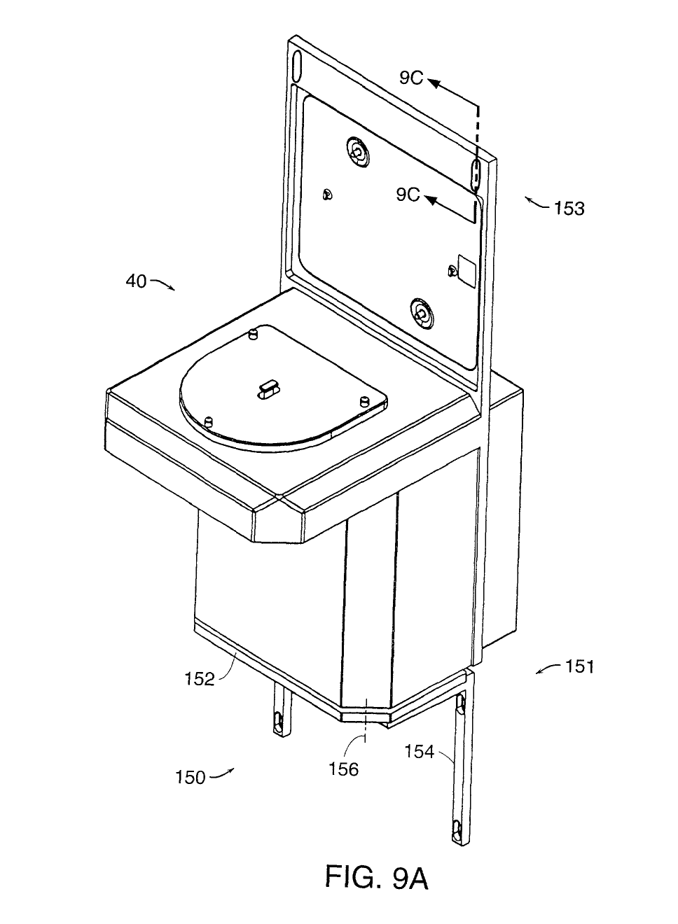

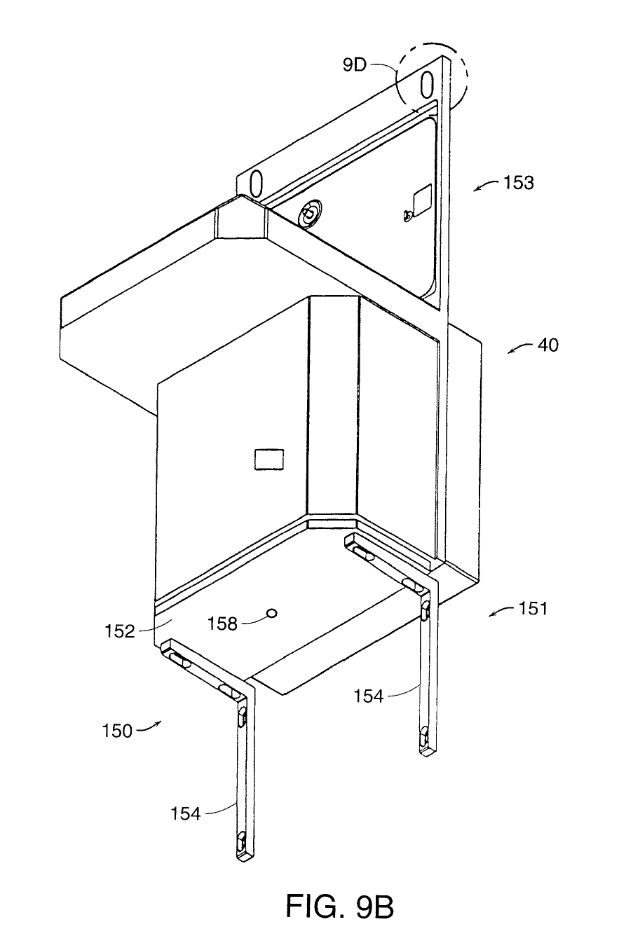

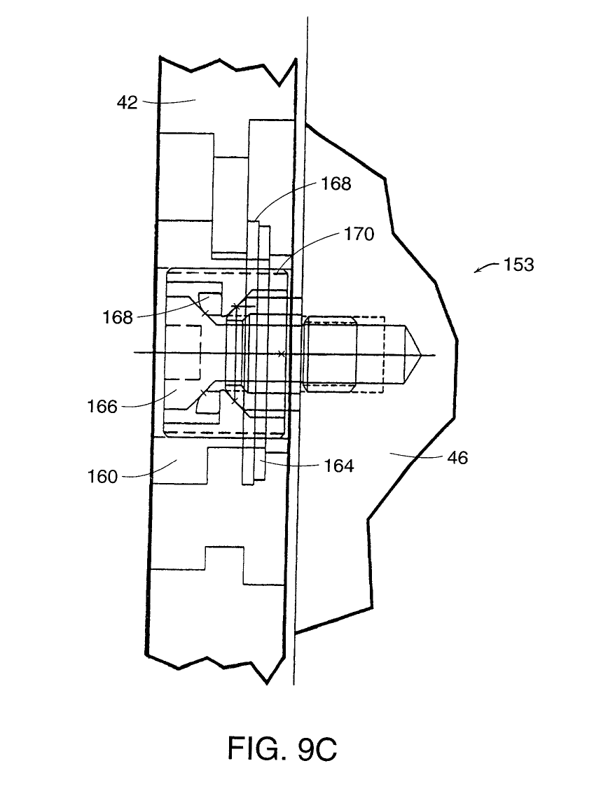

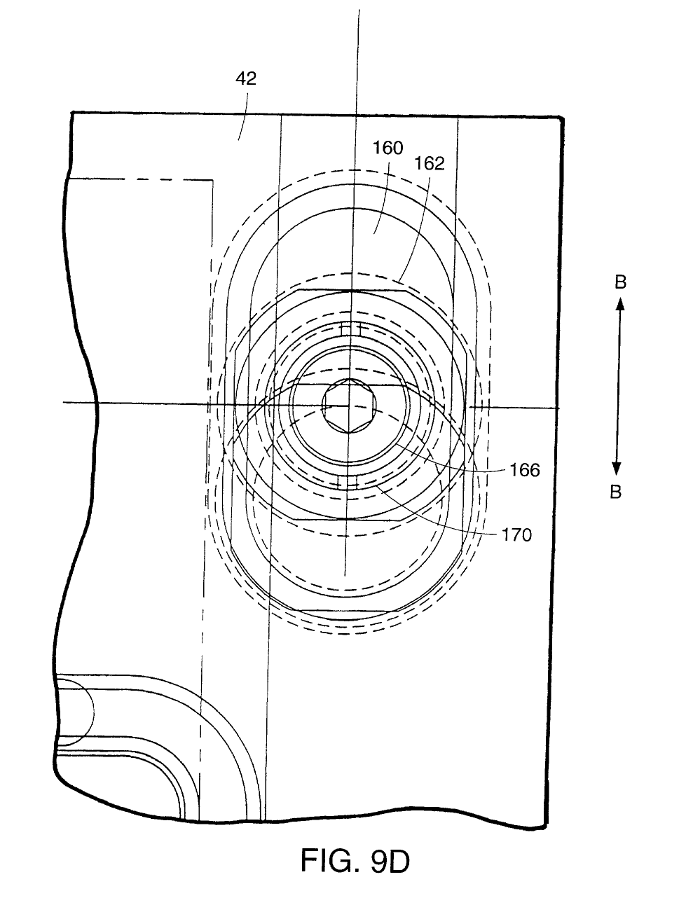

Another improvement over current state of the art pod door opening systems is the implementation of a kinematic tool interface system 150 that results in a greater degree of interchangeability when mounting or dismounting the PDO 40. The kinematic tool interface system 150, as illustrated in FIGS. 9A-9D, includes an upper and lower interface 153, 151. The lower interface 151 includes a kinematic shelf 152 and one or more support brackets 154. In this embodiment, the system 150 includes two brackets 154. The kinematic shelf 152 and support brackets 154 are rigidly coupled and are attached to a wafer processing tool 46 for structural support of the PDO 40. Attached to the kinematic shelf 152 are a plurality of kinematic pins 156. In this embodiment, the system 150 includes three kinematic pins 156. The kinematic pins 156 are independently adjustable and have sufficient range to provide pitch, roll and yaw adjustments. A seismic anchoring device 158 is locked in place once adjustments have been completed.

The upper interface 153 is a spherical adjusting device that conforms to the final position of the lower interface 151. The upper interface 153 is depicted in FIGS. 9C-9D, and includes an upper interface housing 160 retained in the bulkhead 42 by a wave washer 162 and a retaining ring 164. In the illustrated embodiment, the upper interface 153 allows freedom of movement in the vertical plane (arrow B-B). Conformance to the lower interface 151 is enabled by a threaded adjuster 166, which contacts a self-centering ring 168. The ring 168 and housing 160 are adjusted by a cup 170. The resultant interaction of these components allows the upper interface 153 to conform to the final pitch, roll, and yaw position of the lower interface 151.

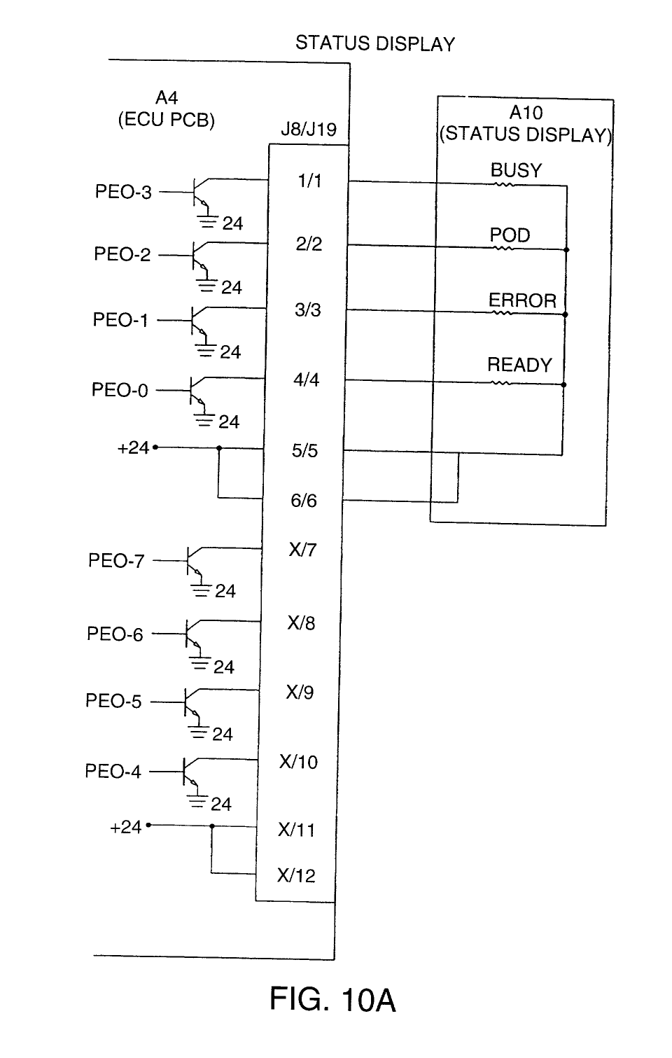

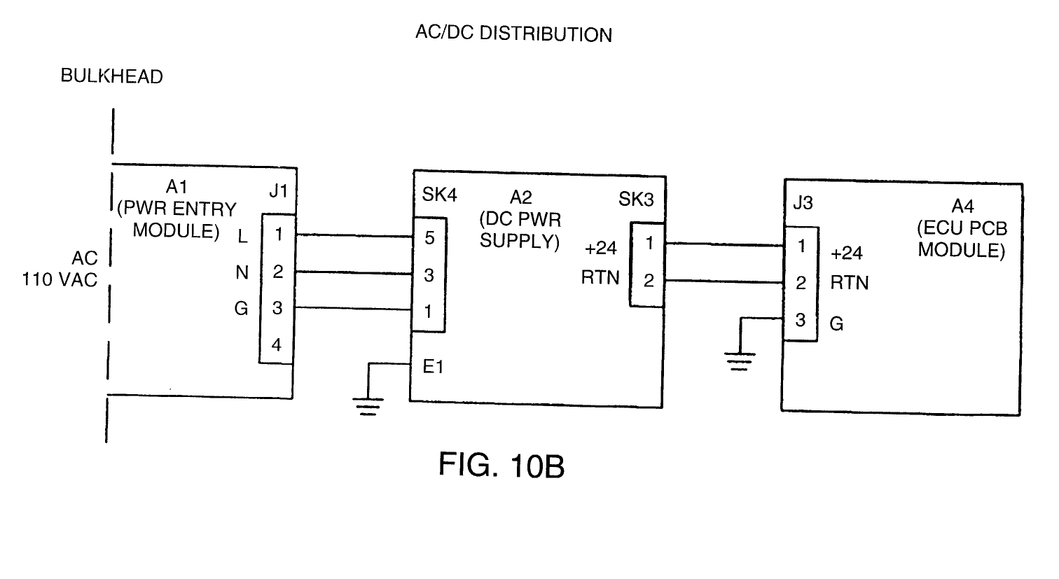

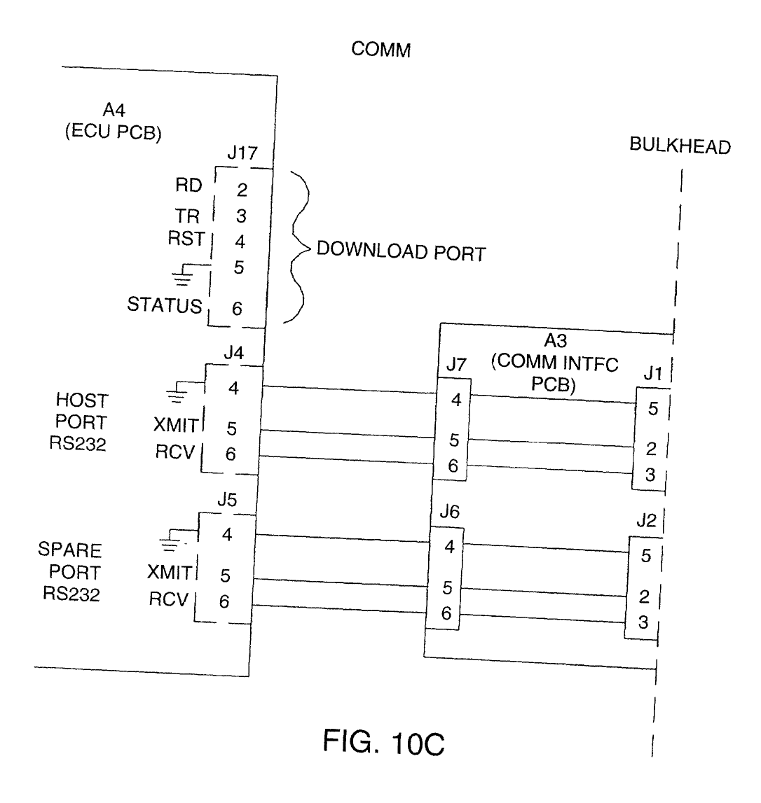

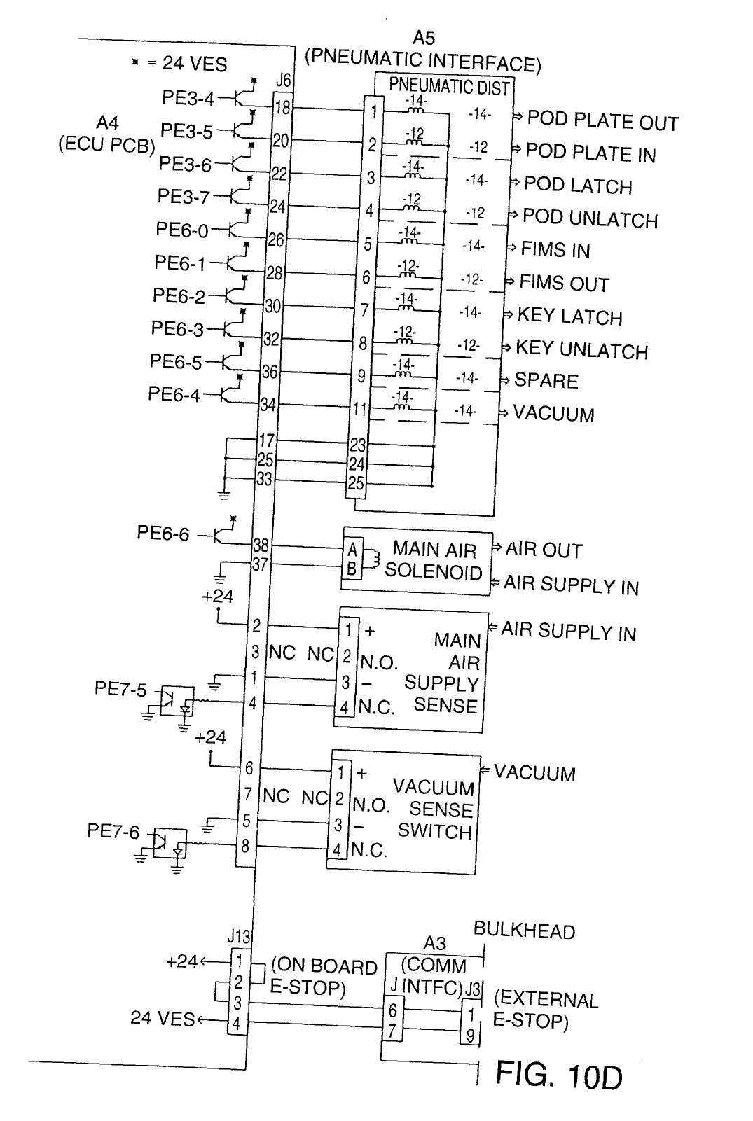

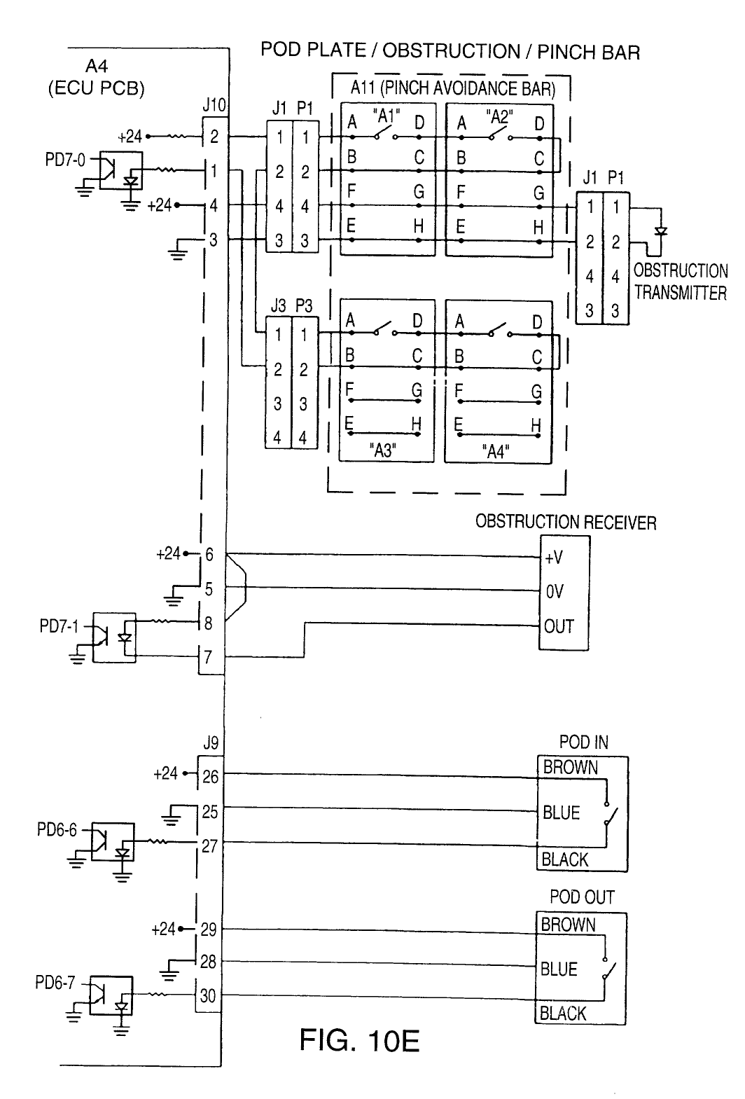

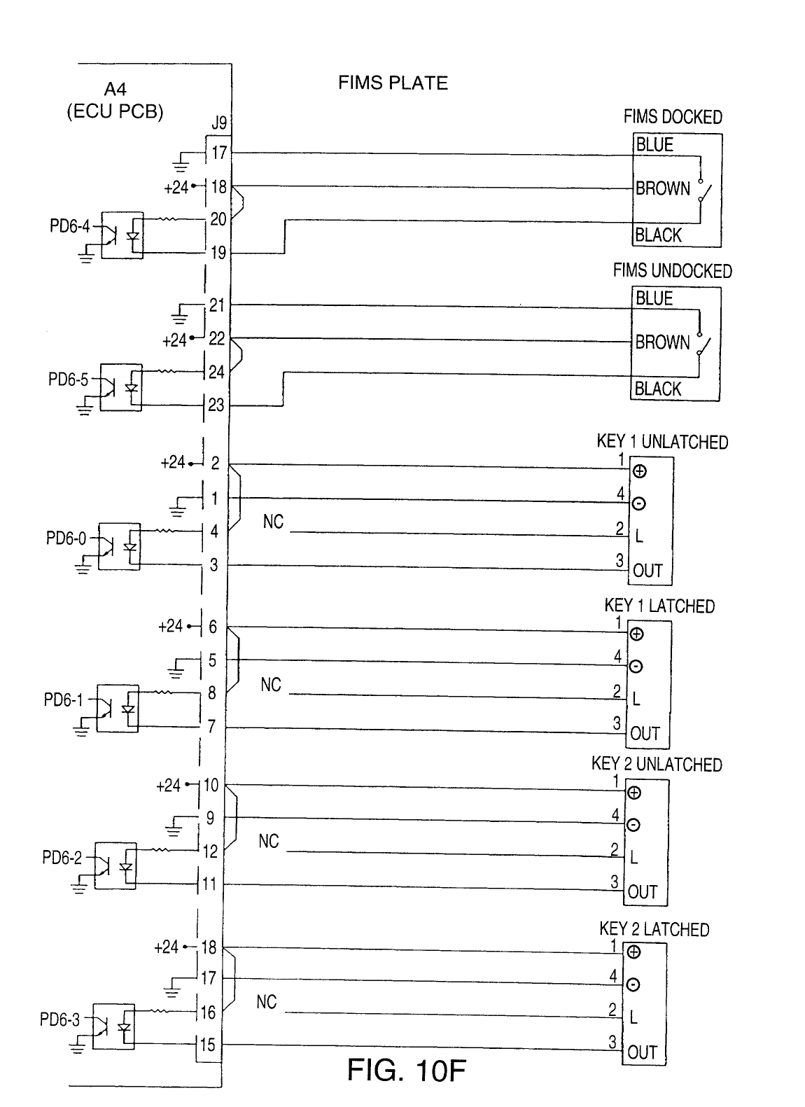

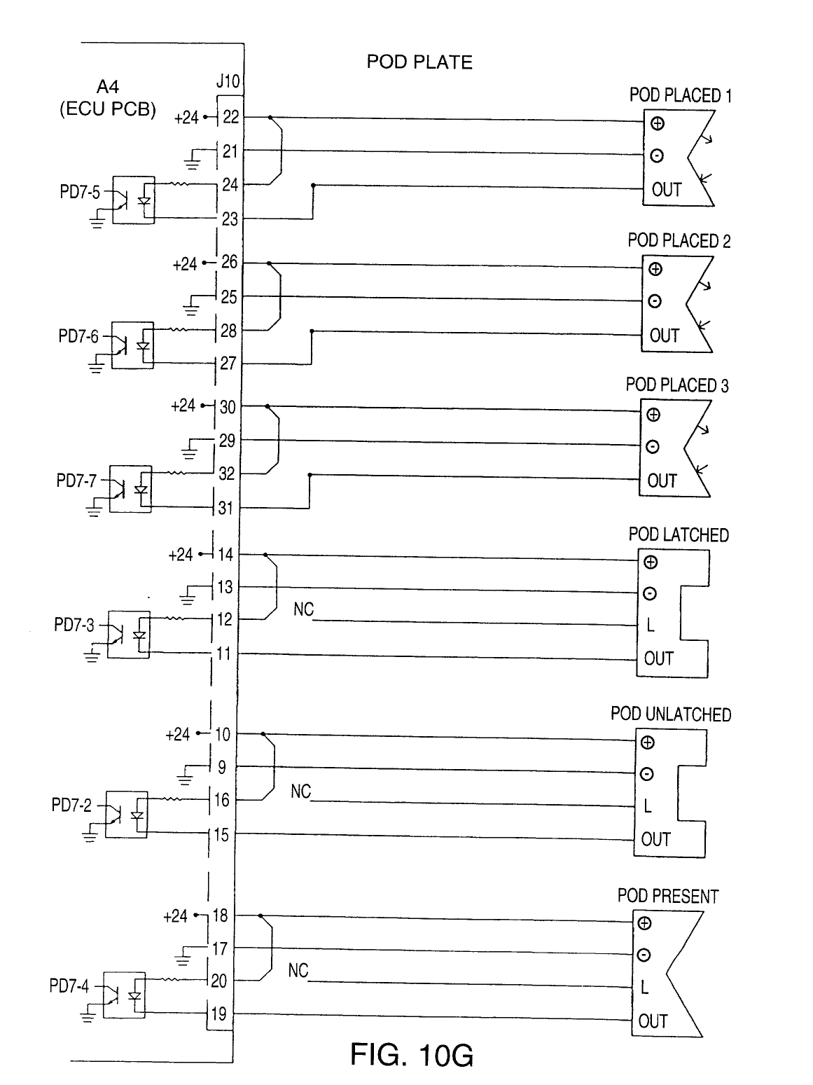

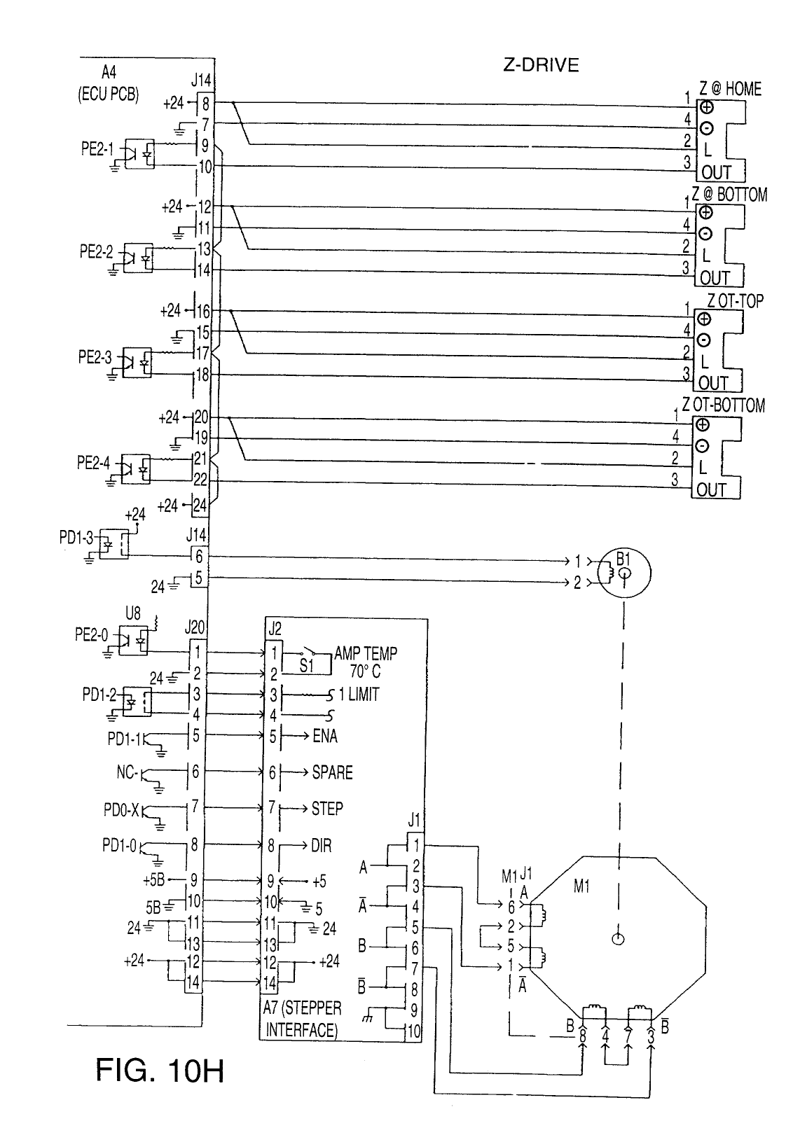

FIGS. 10A-H are wiring diagrams for various components of the pod door opener 40. The wiring diagrams are for illustrative purposes only and will vary depending on the specific configuration of any particular component/system of the pod door opener 40. FIG. 10A is a wiring diagram for a status display for use with a pod door opener 40. FIG. 10B is a wiring diagram depicting the AC/DC power distribution of the pod door opener 40. FIG. 10C is a PDO communications wiring diagram. FIG. 10D is a wiring diagram for a pneumatic interface for the various components/systems of the pod door opener 40. FIG. 10E is a wiring diagram for the pinch avoidance system 143. FIG. 10F is a wiring diagram for a FIMS plate. FIG. 10G is a wiring diagram for the pod drive plate 58. FIG. 10H is a wiring diagram for the vertical positioning system 104.

Having described certain embodiments of the invention, it will be apparent to those of ordinary skill in the art that other embodiments incorporating the concepts disclosed herein may be used without departing from the spirit and scope of the invention. The described embodiments are to be considered in all respects as only illustrative and not restrictive.

What is claimed is:

1. A pod door opener comprising:
a door opening mechanism;
a bulkhead having a seal plane and defining an aperture through which a door of a pod passes when removed by the door opening mechanism; and
a work volume for the door opening mechanism, wherein the volume has a height, width, and depth, and the depth does not exceed 80 mm from the seal plane.

2. The pod door opener of claim 1, wherein the width does not exceed 400 mm, generally horizontally centered on the seal plane.

3. The pod door opener of claim 1, wherein the height does not exceed 439 mm, generally vertically centered on the seal plane.

4. The pod door opener of claim 1, wherein the pod door opener is configured to mount to a semiconductor wafer processing tool that permits a work volume for the door opening mechanism to have a depth of up to about 100 mm.

5. The pod door opener of claim 1, wherein the pod door opener is configured to mount to a semiconductor wafer processing tool that permits a work volume for the door opening mechanism to have a width of up to about 414 mm.

6. The pod door opener of claim 1, wherein the door opening mechanism moves the pod door in a horizontal direction and a vertical direction.

7. The pod door opener of claim 6, wherein the door opening mechanism comprises a door retraction device.

8. The pod door opener of claim 7, wherein the door retraction device comprises a bidirectional propulsion device selected from the group consisting of an electromechanical system, an hydraulic system, and a pneumatic system.

9. The pod door opener of claim 6, wherein the door opening mechanism further comprises a vertical positioning system, the vertical positioning system comprising:
a lead screw;
a conformal rolling nut; and
an actuator.

10. The pod door opener of claim 6, wherein the door opening mechanism further comprises a vertical positioning system selected form the group consisting of a guided telescopic lift device, a linear electric motor, a cam driven system, an hydraulic actuator, a pneumatic actuator, a cable drive system, and a magnetically coupled device.

11. The pod door opener of claim 1, further comprising a pinch avoidance system comprising:
a frame coupled to the bulkhead; and
at least one switch disposed between the frame and the bulkhead.

12. The pod door opener of claim 1, further comprising a door key latch mechanism for grasping the pod door, the door key latch mechanism comprising:
a door interface plate coupled to the pod door opener;
at least one door key latch coupled to the interface plate;
a bidirectional propulsion device coupled to the interface plate; and
a yoke coupled between the door key latch and the bi-directional propulsion device for translating a linear motion from the bi-directional propulsion device to a rotary motion on the door key latch.

13. The pod door opener of claim 12, wherein the bi-directional propulsion device is selected from the group consisting of an electromechanical system, an hydraulic system, and a pneumatic system.

14. The pod door opener of claim 1, wherein the bulkhead comprises a monocoque construction.

15. The pod door opener of claim 1, further comprising a sensor for sensing placement and position of the pod.

16. A kinematic tool interface system for use with a pod door opener, the kinematic tool interface system comprising:
a lower interface including a kinematic shelf and at least one support bracket, wherein the kinematic shelf and the at least one support bracket can be coupled rigidly to a wafer-processing tool;
at least one kinematic pin disposed on the kinematic shelf, wherein the at least one kinematic pin is independently adjustable and has a range sufficient to perform pitch, roll, and yaw adjustments to the pod door opener; and
a seismic anchoring device disposed through an underside of the kinematic shelf.

17. The kinematic tool interface system of claim 16 further comprising at least one upper interface for securing the pod door opener to the wafer-processing tool.
